(19) United States
(12) Patent Application Publication
(10) Pub. No.: US 2014/0189566 A1
(43) Pub. Date: Jul. 3, 2014

(54) METHOD AND AN APPARATUS FOR PROCESSING AT LEAST TWO SCREENS

(71) Applicant: LG ELECTRONICS INC., Seoul (KR)

(72) Inventor: Jihyun KIM, Seoul (KR)

(73) Assignee: LG ELECTRONICS INC., Seoul (KR)

(21) Appl. No.: 13/781,341

(22) Filed: Feb. 28, 2013

(30) Foreign Application Priority Data
Dec. 31, 2012 (KR) 10-2012-0157821

(51) Int. Cl. G06F 3/0481

(52) U.S. Cl. CPC G06F 3/04817
USPC 715/773

(57) ABSTRACT

An image processing method and apparatus for processing at least two screens are discussed. The image processing apparatus for processing two or more screens includes: a display panel for displaying a first screen and a second screen; a user input unit for receiving a user input signal; and a processor for dividing each of the first screen and the second screen into a main screen and a sub screen in response to some of the user input signals, displaying a screen-touch keyboard for inputting a letter, adjusting the position or size of at least one screen from among the first screen and the second screen, and displaying the adjusted resultant screen.

This application claims the benefit of Korean Patent Application No. 10-2012-0157821, filed on Dec. 31, 2012, which is hereby incorporated by reference as if fully set forth herein.

### BACKGROUND OF THE INVENTION

1. Field of the Invention

The present invention relates to a method and apparatus for processing at least two screens, and more particularly to an image processing method and apparatus for simultaneously displaying at least two screens and screen-touch keyboards related to respective screens.

2. Discussion of the Related Art

If a user who uses a touch screen touches letters or a specific position displayed on the touch screen without using a keyboard, the touch screen recognizes the touched position or letter and allows specific processing for the recognized information to be performed using the stored software in such a manner that the user can directly input a desired command through the touch screen.

For example, the touch screen is implemented by attaching a touch panel to a display screen of a general monitor. Invisible infrared rays flow in the touch panel so that many rectangular lattices are formed. Thus, if the user touches any one of the lattices using his or her finger or other object, the touch panel enables the user to recognize the touched position.

Therefore, if the user's finger touches a letter or picture displayed on a touch panel of the touch screen, the touch screen recognizes what user-selected information corresponding to the touched position is, and performs computer processing of a command corresponding to the user-selected information, so that the user can easily obtain desired information through the touch screen. In recent times, a mobile image processing device including a portable audio/video (A/V) receiver has been developed to include a touch-screen function therein.

The size of a display panel contained in the mobile image processing device occupies most parts of the mobile image processing device. That is, the latest mobile image processing device aims to include no bezel therein. Therefore, a screen-touch keyboard is displayed on a display panel such that letters entered by the user can be received. However, the screen used by the user and the screen-touch keyboard must be simultaneously displayed on the display panel, such that the user may temporarily have difficulty in conveniently using the screen. The above-mentioned problems become more serious when a plurality of screens are displayed on a single display panel and a screen-touch keyboard for allowing a user to input a letter displayed on the screen is displayed.

### SUMMARY OF THE INVENTION

Accordingly, the present invention is directed to a method and apparatus for processing at least two screens that substantially obviate one or more problems due to limitations and disadvantages of the related art.

An object of the present invention is to provide an image processing method and apparatus for allowing the user to conveniently use the screen when processing at least two screens and a screen-touch keyboard.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an image processing apparatus for processing two or more screens includes: a display panel for displaying a first screen and a second screen; a user input unit for receiving a user input signal; and a processor for dividing each of the first screen and the second screen into a main screen and a sub screen in response to some of the user input signals, displaying a screen-touch keyboard for inputting a letter, adjusting the position or size of at least one screen from among the first screen and the second screen, and displaying the adjusted resultant screen, wherein the processor, if the letter input caused by the screen-touch keyboard is ended, controls the position or size of at least one screen from among the first screen and the second screen to return to the original position or size of the at least one screen, and displays the at least one screen having the original size at the original position, the processor maintains a predetermined position and size of the screen-touch keyboard, irrespective of adjustment of the position or size of the first screen and the second screen, so that the resultant screen-touch keyboard is displayed, and the processor controls a main-screen indicator for identifying a screen identified as the main screen to be displayed.

In order to guarantee a display region of the screen-touch keyboard, the processor may reduce the first screen and the second screen at the same ratio, and may display the reduced first and second screens.

A screen focused by the user from among the first screen and the second screen may be identified as the main screen, and the remaining screen may be identified as the sub screen.

The image processing apparatus may further include: a pupil recognition sensor for collecting information regarding a user's pupil position, wherein the processor identifies the first or second screen focused by the user's pupil as the main screen on the basis of the collected pupil position.

The processor may identify a user-touched screen from among the first screen and the second screen as the main screen.

The image processing apparatus may further include: a voice input receiver for receiving a user's voice input signal, wherein the processor identifies the first or second screen designated by the received user's voice input, as the main screen.

The processor may zoom out and reduce only the sub-screen so that the resultant sub-screen is displayed.

The processor may shift the main screen or the sub-screen by a predetermined distance corresponding to a display region of the screen-touch keyboard, and display the main screen or the sub-screen at the shifted position; and the processor, if the main screen overlaps with the sub-screen due to the shifting action, may control the main screen to be displayed at the overlap region.

The processor may shift the main screen or the sub-screen by a predetermined distance corresponding to the display region of the screen-touch keyboard, sever a predetermined-sized region corresponding to the shifted region from the sub-screen, and display the resultant screens.

The processor may control the screen-touch keyboard to be displayed on the sub-screen.

The display panel may be located at one side of the image processing apparatus so as to simultaneously display the first screen and the second screen.

The display panel may be located not only at one side but also at the other side of the image processing apparatus, wherein the first screen is displayed at the one side and the second screen is displayed at the other side.

The processor may rearrange a keyboard of the screen-touch keyboard, and may divide the screen-touch keyboard into two regions such that the screen-touch keyboard is displayed on the two regions at left and right corners of the display panel.

The processor may rotate the first screen or the second screen clockwise or counterclockwise by 90 degrees, and may display the rotated resultant first or second screen.

The image processing may further include: a keyboard trigger for receiving a user input signal for displaying the screen-touch keyboard; and a location control button for receiving a user input signal for controlling the display position of the screen-touch keyboard.

The processor, upon receiving a location control input signal from the user through the keyboard location control button, may shift the screen touch keyboard from the first screen to the second screen of the display screen, and may display the shifted result.

The main-screen indicator may identify the main screen by adjusting brightness of the screen identified as the main screen, may identify the main screen by increasing transparency of the screen identified as the sub-screen, may identify the main screen by forming a border of the screen identified as the main screen, or may identify the main screen by displaying a predetermined sign on the screen identified as the main screen.

In another aspect of the present invention, an image processing method for processing two or more screens includes: displaying a first screen and a second screen; receiving a user input signal; dividing each of the first screen and the second screen into a main screen and a sub screen in response to some of the user input signals, displaying a screen-touch keyboard for inputting a letter, adjusting the position or size of at least one screen from among the first screen and the second screen, and displaying the adjusted resultant screen, wherein predetermined position and size of the screen-touch keyboard are maintained, irrespective of adjustment of the position or size of the first screen and the second screen, so that the resultant screen-touch keyboard is displayed; controlling display of a main-screen indicator for identifying a screen identified as the main screen; and if the letter input caused by the screen-touch keyboard is ended, controlling the position or size of at least one screen from among the first screen and the second screen to return to the original position or size of the at least one screen, and displaying the at least one screen having the original size at the original position.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 illustrates an image processing apparatus for displaying at least two screens according to an embodiment of the present invention.

FIG. 2 illustrates an image processing apparatus for processing at least two screens according to an embodiment of the present invention.

FIG. 3 illustrates an image processing apparatus for identifying a focus pointed by a user on the screen according to an embodiment of the present invention.

FIG. 4 illustrates an image processing apparatus for processing at least two screens according to another embodiment of the present invention.

FIG. 5 illustrates an image processing apparatus for processing at least two screens according to another embodiment of the present invention.

FIG. 6 illustrates an image processing apparatus for processing a display of the screen-touch keyboard according to an embodiment of the present invention.

FIG. 7 illustrates an image processing apparatus for processing at least two screens according to another embodiment of the present invention.

FIG. 8 illustrates an image processing apparatus for processing at least two screens according to another embodiment of the present invention.

FIG. 9 illustrates an image processing apparatus for processing a display of the screen-touch keyboard when at least two screens are displayed according to an embodiment of the present invention.

FIG. 10 is a block diagram illustrating an image processing apparatus for processing at least two screens according to an embodiment of the present invention.

### DETAILED DESCRIPTION OF THE INVENTION

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention.

Although most terms of elements in this specification have been selected from general ones widely used in the art taking into consideration functions thereof in this specification, the terms may be changed depending on the intention or convention of those skilled in the art or the introduction of new technology. Some terms have been arbitrarily selected by the applicant and their meanings are explained in the following description as needed. Thus, the terms used in this specification should be construed based on the overall content of this specification together with the actual meanings of the terms rather than their simple names or meanings.

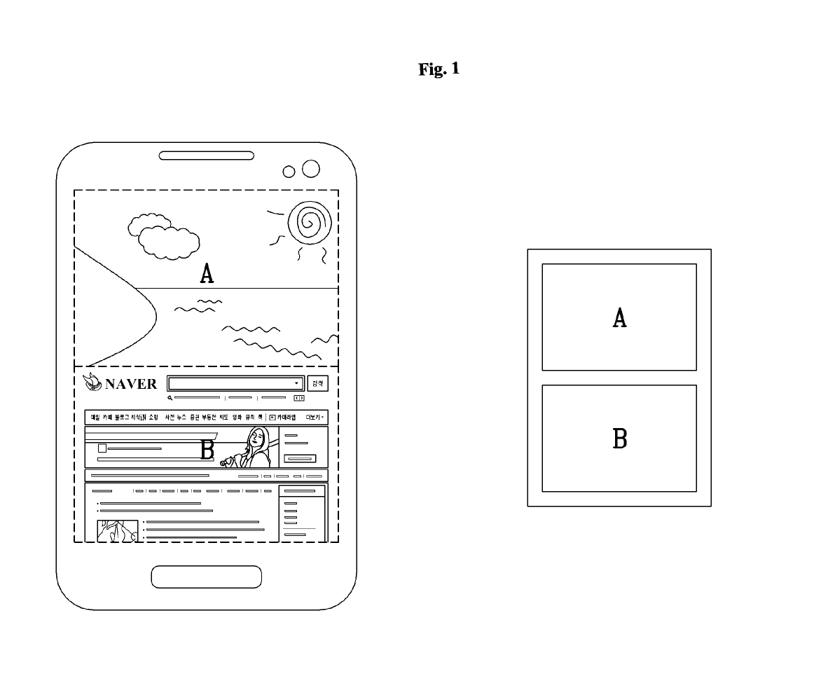

FIG. 1 illustrates an image processing apparatus for displaying at least two screens according to an embodiment of the present invention.

Referring to FIG. 1, at least two screens may be displayed on a single display panel. One display panel is divided into two or more regions, and each screen can be displayed on each region. A screen is displayed on a first region of the display panel, and B screen is displayed on a second region. A display of each screen can be separately controlled according to a user-selected command or a control command of the image processing apparatus.

Although not shown in FIG. 1, embodiments for other display panels may also be used as necessary. For example, the display panel may be located not only at one side of the image processing apparatus but also at the other side thereof. If the image processing apparatus includes two or more sides, a plurality of display panels may be present on two or more sides. In this case, each display panel can display each image thereon.

In accordance with another embodiment, a display panel can be folded. That is, a display panel of one side is folded so that two or more surfaces of one side and the other side can display respective screens.

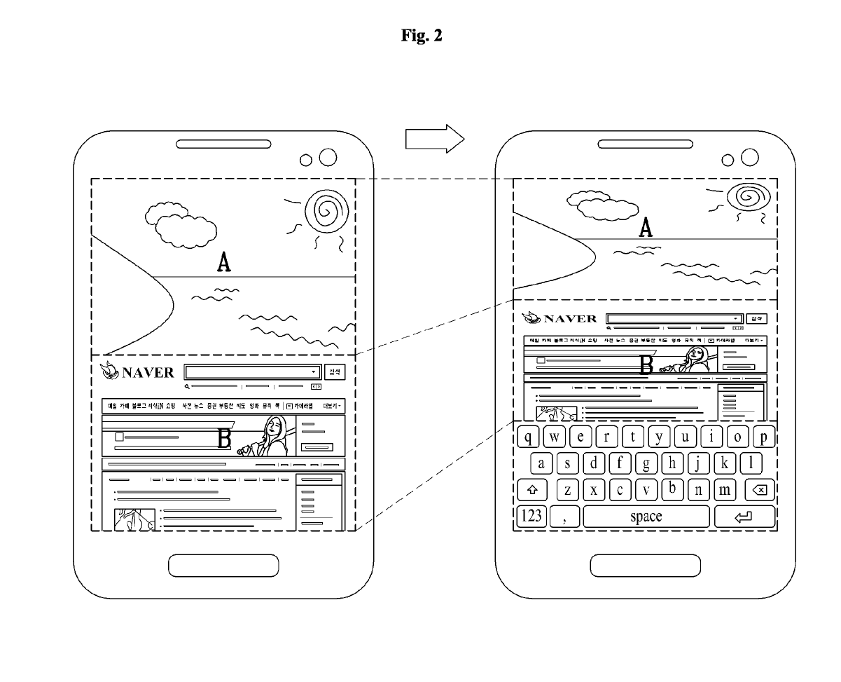

FIG. 2 illustrates an image processing apparatus for processing at least two screens according to an embodiment of the present invention.

In order to display the screen-touch keyboard, the image processing apparatus may zoom out from at least two displayed screens at a predetermined ratio, and display the zoomed-out images.

The image processing apparatus may zoom out from each of at least two display screens at the same ratio, and display the zoomed-out screens such that the at least two screens can be simultaneously displayed on the remaining regions of the display panel other than a specific region where the screen-touch keyboard is displayed. In accordance with another embodiment, each of two or more display screens is zoomed in or zoomed out at different ratios in such a manner that two or more screens can be simultaneously displayed on the remaining regions of the display panel other than a specific region where the screen-touch keyboard is displayed.

If the user finishes utilizing the screen-touch keyboard so that the screen-touch keyboard is excluded from the display screen, the image processing apparatus can restore to the positions or sizes of two or more screens.

The image processing apparatus according to one embodiment of the present invention may further include a control button capable of controlling the start or end of displaying of the screen-touch keyboard. The screen-touch keyboard can be simultaneously displayed according to a user's touch input to the screen region. However, when two or more screens are simultaneously displayed, simultaneous displaying of the screen-touch keyboard by a user's screen-touch input may cause user's inconvenience. For example, in order to guarantee a region of the screen-touch keyboard, the image processing apparatus must reduce the size of screen or shift the screen, irrespective of which one of two or more screens is focused by a user. In this case, the user may temporarily miss the position of a user-focused screen. Therefore, when two or more screens are displayed, the image processing apparatus needs to definitely recognize the intention of the user who desires to view the screen-touch keyboard. For example, the image processing apparatus may further include an input receiver for receiving an input for displaying the screen-touch keyboard. For example, the input receiver for activating an input signal for displaying the screen-touch keyboard may be located at a side of the image processing apparatus. In another embodiment, the input receiver for activating an input signal for displaying the screen-touch keyboard may be located at an opposite side of one side where the display panel is located. In accordance with the present invention, only when the screen-touch keyboard is needed for the display panel, the user can control display of the screen-touch keyboard such that user's concentration on the screen is not interrupted.

The input receiver for an input signal for displaying the screen-touch keyboard can receive not only an input signal indicating whether the screen-touch keyboard is displayed but also an additional control input. For example, the above-mentioned input receiver can receive an input signal for adjusting a display position of the screen-touch keyboard. The user can precisely adjust the display position of the screen-touch keyboard through the input receiver, such that the displayed screen-touch keyboard enables the user to continuously focus on the screen without any restriction.

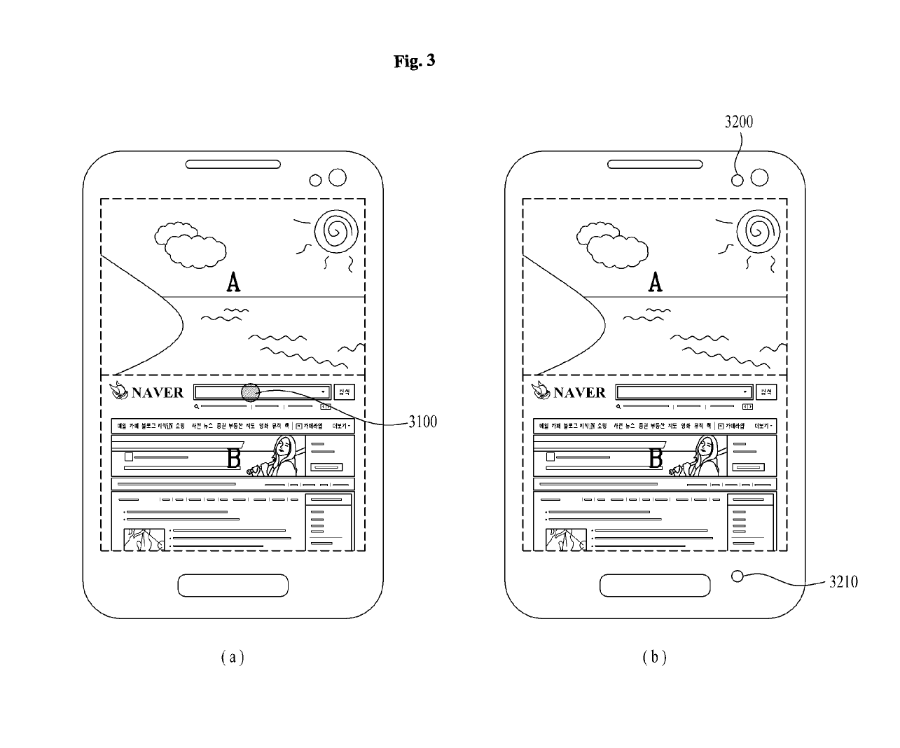

FIG. 3 illustrates an image processing apparatus for identifying the user's focus on the screen according to an embodiment of the present invention.

Referring to FIG. 3(a), the image processing apparatus can identify a user-focused screen according to the user's screen-touch input.

If the user touches a specific region 3100 of the B screen, the image processing apparatus determines that the B screen is focused by the user.

Alternatively, the image processing apparatus can identify the user-focused screen by the user who touches the A or B screen. In this case, the image processing apparatus may determine which one of the A screen and the B screen is finally touched by the user, such that the determined screen is identified as a current user-focused screen.

In another embodiment, the image processing apparatus can determine a specific screen that is very frequently touched by the user to be a current user-focused screen. The image processing apparatus detects how many times the user touches a specific screen for a predetermined time before reaching a specific time indicating whether the user's focus on the screen exists, such that it can identify which one of the screens includes the user's focus on the basis of the detected number of the user's touch actions.

In another embodiment, the image processing apparatus can identify which screen is focused by the user in response to a user's voice input. For example, the user can audibly indicate his or her focused screen from among a plurality of screens. Alternatively, the image processing apparatus receives the user's voice signal obtained when the user consciously or unconsciously reads any of letters displayed on the screen, and analyzes the corresponding voice signal, such that the screen including the corresponding letter can be identified as a current user-focused screen.

Referring to FIG. 3(b), the image processing apparatus may include a separate sensor for identifying the user's focus.

For example, the image processing apparatus may include a pupil recognition sensor 3200 for collecting information as to which one of the A screen and the B screen is focused by the user. The image processing apparatus can determine which one of the displayed screens is focused by the user's eyes using the pupil recognition sensor. The image processing apparatus can identify the determined screen as a screen where the current user's focus exists. In order to more definitely recognize the position of the user's pupil, the image processing apparatus may include a plurality of pupil recognition sensors 3200 and 3210.

The image processing apparatus may identify a current screen focused by the user as a main screen, and may identify the remaining screens as sub screens. A processor contained in the image processing apparatus may control display of a main screen indicator indicating a main screen. Although the main screen indicator may be merely a simple sign, it should be noted that the main screen indicator may include a series of display actions through which the user can recognize a specific screen as a main screen. For example, the main screen indicator adjusts brightness of the screen serving as the main screen. As a result, the main screen is displayed more brightly than the sub screen, transparency of the sub screen is increased, a higher-definition screen image from among two screen images may be identified as the main screen, a border of the main screen is formed in a manner that the main screen can be identified on the basis of the presence or absence of the border, and a specific sign or mark is displayed on the main screen such that the user can easily recognize the main screen.

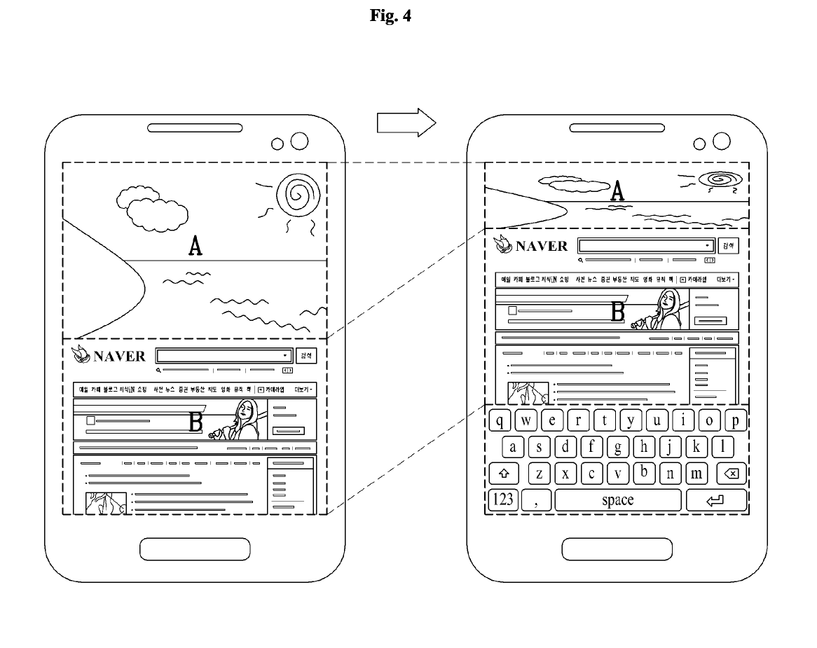

FIG. 4 illustrates an image processing apparatus for processing at least two screens according to another embodiment of the present invention.

In order to obtain a specific region where the screen-touch keyboard is displayed, the image processing apparatus zooms out or reduces a specific screen from among a plurality of screens, such that the zoomed-out screen image can be displayed.

As can be seen from FIG. 4, when the screen-touch keyboard is additionally displayed as shown in the right drawing of FIG. 4, the image processing apparatus maintains the same-sized B screen and changes only the display position of the B screen, and reduces the size of A screen.

The image processing apparatus maintains or enlarges the size of the screen including the user's focus even when the screen-touch keyboard is displayed, may reduce the size of a different screen not including the user's focus or may remove the different screen from the display.

Referring to FIG. 4, if the user's focus is located at the B screen, the image processing apparatus does not change the size of B screen, shifts only the display position of the B screen to another position, and displays the resultant B screen at the shifted position. In contrast, the image processing apparatus reduces the size of the A screen not including the user's focus and displays the resultant A screen, such that it can guarantee a display region of the screen-touch keyboard.

Although not shown in FIG. 4, if the screen-touch keyboard is displayed, the image processing apparatus removes the A screen including no user's focus from the display, and zooms in on the B screen image including the user's focus at the remaining display panel region other than a display region of the screen-touch keyboard.

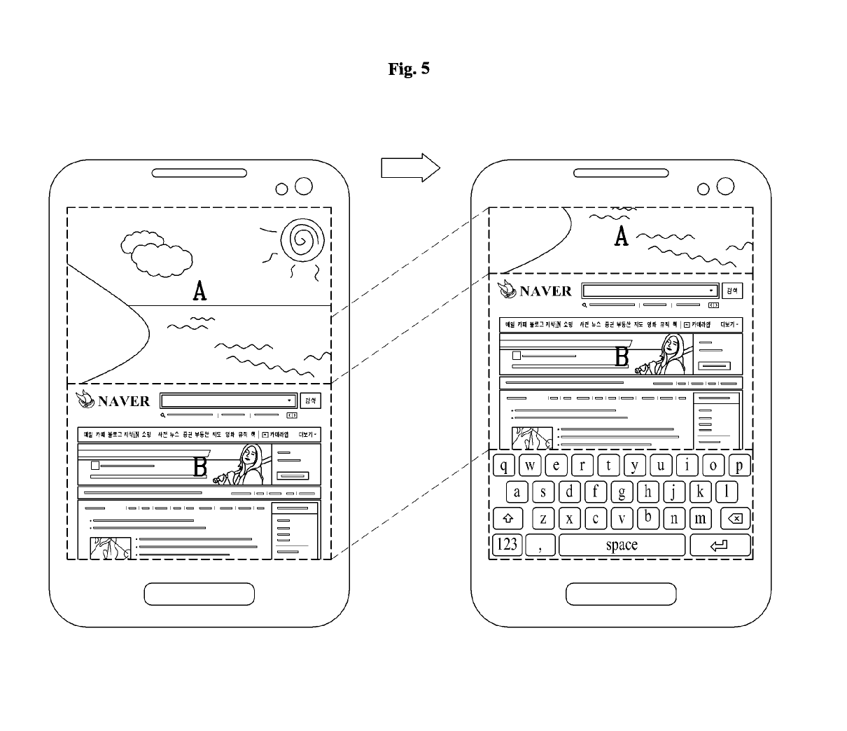

FIG. 5 illustrates an image processing apparatus for processing at least two screens according to another embodiment of the present invention.

If the screen-touch keyboard is displayed, the image processing apparatus shifts the position of at least one screen image from among a plurality of displayed screen images, and displays the shifted result.

For example, the image processing apparatus maintains the size of each displayed screen image without any change, shifts at least one screen to a display region other than a display region of the screen-touch keyboard, and displays the shifted result. Due to the shifting of the at least one screen, some parts of the screen not displayed on the display panel may be generated. In the case of shifting at least one screen, the image processing apparatus may control the entire screen including the user's focus to be displayed. In other words, if the at least one screen is shifted, some parts of the screen escaping from the display region may occur, such that the image processing apparatus may prevent some parts of the screen from escaping from the user-focused screen. That is, the image processing apparatus shifts and displays at least one screen in such a manner that some parts of the screen not focused by the user are excluded from the display.

Referring to FIG. 5, in order to guarantee the display region of the screen-touch keyboard while the screen-touch keyboard is displayed, each of the A screen and the B screen is shifted to an upper end of the display panel. The A screen and the B screen are not reduced or enlarged, a predetermined size of the A or B screen is maintained, but some parts of the A screen escape from the display region so that some parts of the A screen are not displayed.

For example, if the user-focused screen is the B screen, the image processing apparatus shifts the B screen to be entirely displayed, and shifts the A screen in such a manner that some parts of the A screen not focused by the user are not displayed.

Although not shown in FIG. 5, if the A screen is identified as the user-focused screen according to another embodiment, the image processing apparatus maintains the position and size of the A screen without any change, and controls the screen-touch keyboard to be displayed on the B screen not focused by the user. In this case, in order to guarantee the display region of the screen-touch keyboard, the B screen is shifted to an upper end of the display panel. If the B screen overlaps with the A screen due to the shifting of the B screen, the image processing apparatus may not display the B screen region corresponding to the overlap region. Alternatively, the image processing apparatus may maintain the position of B screen, and at the same time may not display the B screen region corresponding to the display region of the screen-touch keyboard.

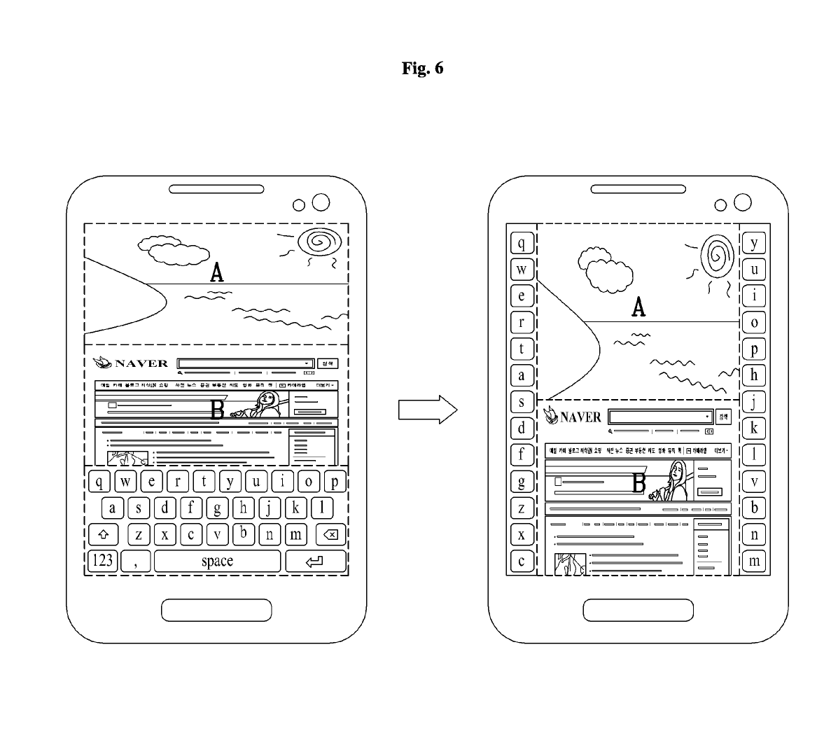

FIG. 6 illustrates an image processing apparatus for processing a display of the screen-touch keyboard according to an embodiment of the present invention.

The screen-touch keyboard may be displayed at a lower end of the display panel. Alternatively, the screen-touch keyboard may be displayed at a lateral corner of the display panel.

Generally, the important contents of the corresponding screen are not displayed at a lateral part of the image. Therefore, the screen-touch keyboard may be rearranged and displayed on the lateral part of the screen.

Referring to FIG. 6, it can be recognized that the image processing apparatus for displaying the A screen and the B screen reduces the size of A and B screens and displays the reduced A and B screens. However, the user takes small interest in data or image displayed at left/right corners of the A and B screens, and the typical screen-touch keyboard may be rearranged and displayed at the left/right corner.

There is no special rule in rearrangement of the screen-touch keyboard. The screen-touch keyboard may be rearranged according to user's convenience and the frequency of use of letters. Alternatively, the image processing apparatus rearranges and displays a character string touched by the user's left hand on the typical screen touch keyboard at a left corner of the display panel. A character string touched by the user's right hand may be rearranged and displayed at the right corner of the display panel.

Although FIG. 6 shows that the A and B screens are reduced at the remaining regions other than the screen-touch keyboard displayed at the left/right corners of the display panel, the scope or spirit of the present invention is not limited thereto. If necessary, the A or B screen remains unchanged, and a display region of the rearranged screen-touch keyboard is severed and only the remaining region may be displayed.

In the case where the user uses two or more screens, the embodiment of the present invention can display the screen-touch keyboard without restricting user's concentration on the screen.

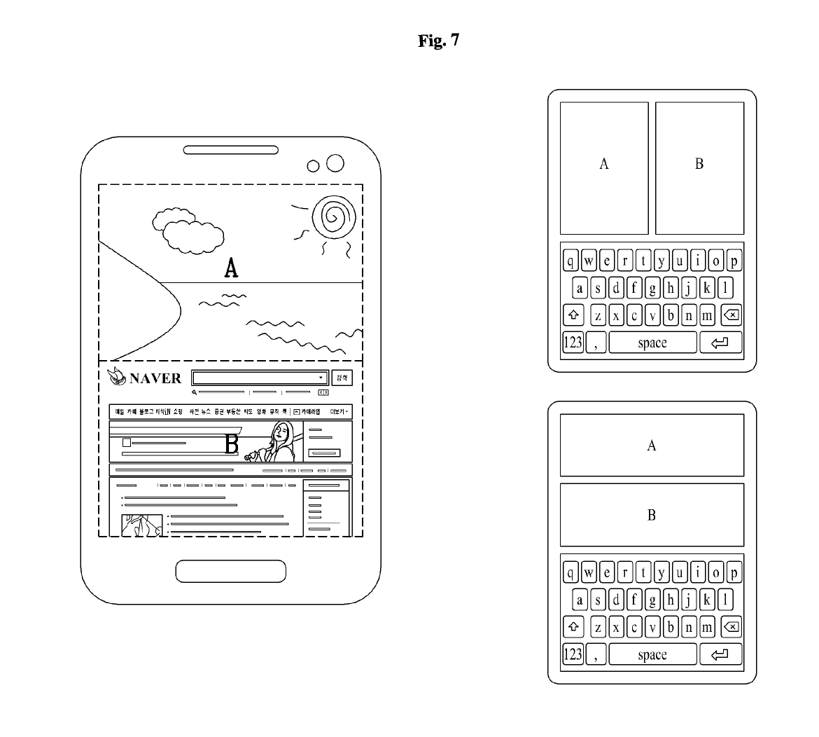

FIG. 7 illustrates an image processing apparatus for processing at least two screens according to another embodiment of the present invention.

Referring to FIG. 7(a), if the image processing apparatus displays the screen-touch keyboard, the A or B screen is reduced in size, and rotates by 90 or −90 degrees, such that the resultant A and B screens are displayed. Alternatively, in the case where the image processing apparatus displays the screen-touch keyboard, the A or B screen remains unchanged, only the horizontal size of the A or B screen is reduced, such that the same-sized A and B screens can be displayed at left/right sides.

Referring to FIG. 7(b), in the case where the image processing apparatus displays the screen-touch keyboard, only the vertical size of the A or B screen is reduced, such that the reduced A and B screens are displayed at the region other than the screen-touch keyboard region.

In accordance with the user's selection or control, the image processing apparatus may change a display format of two or more screens such that a display format of FIG. 7(a) can be changed to a display format of FIG. 7(b).

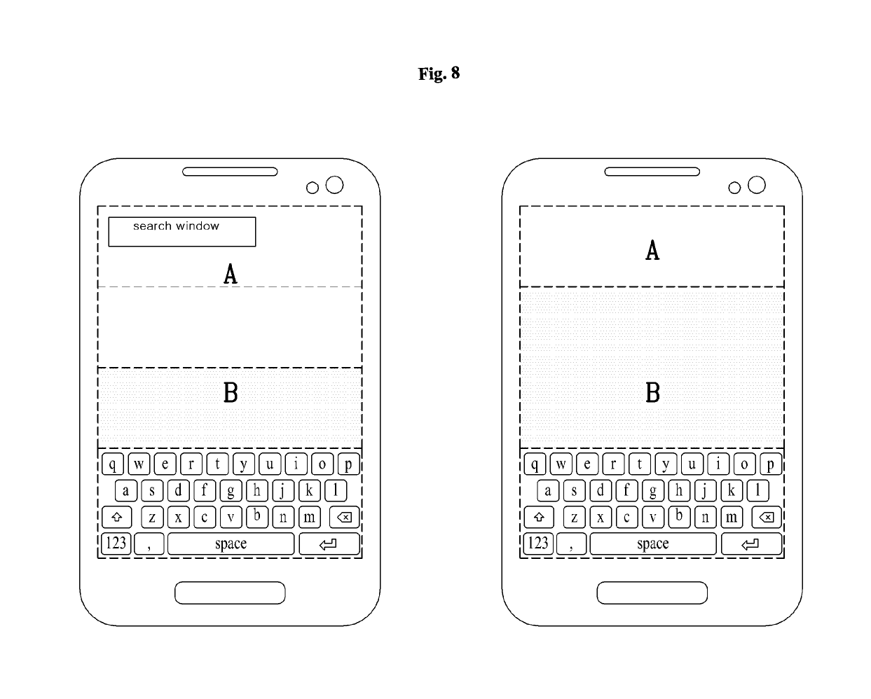

FIG. 8 illustrates an image processing apparatus for processing at least two screens according to another embodiment of the present invention.

In the case where the image processing apparatus must display the screen-touch keyboard, the position of at least one screen from among a plurality of displayed screens is shifted to another position, such that the at least one screen may be displayed at the shifted position. A plurality of screens may overlap with each other due to shifting of at least one screen. In this case, the image processing apparatus may control the user-focused screen region to be displayed at the screen overlap region.

Referring to FIG. 8(a), in order to guarantee a display region of the screen-touch keyboard, the B screen is shifted to an upper end by a predetermined distance corresponding to a display region of the screen-touch keyboard, such that the resultant B screen can be displayed at the shifted position. In this case, if the user-focused screen is the A screen, the image processing apparatus may display only the A screen image at the overlap region of the A and B screens.

Referring to FIG. 8(b), in order to guarantee a display region of the screen-touch keyboard; the image processing apparatus shifts the B screen to an upper end by a predetermined distance corresponding to a display region of the screen-touch keyboard, such that the resultant B screen can be displayed at the shifted position. If the user-focused screen is the B screen, the image processing apparatus may display only the B screen image at the overlap region of the A and B screens.

If display of the screen-touch keyboard is ended, the image processing apparatus controls the A screen and the B screen to return to their original positions so that the A and B screens are displayed at their original positions.

In accordance with an exemplary method for processing two or more screens, the size of each screen is not reduced or enlarged, and each screen is temporarily shifted and displayed at the shifted position, such that user's concentration on the screen is not interrupted and the screen-touch keyboard can be displayed.

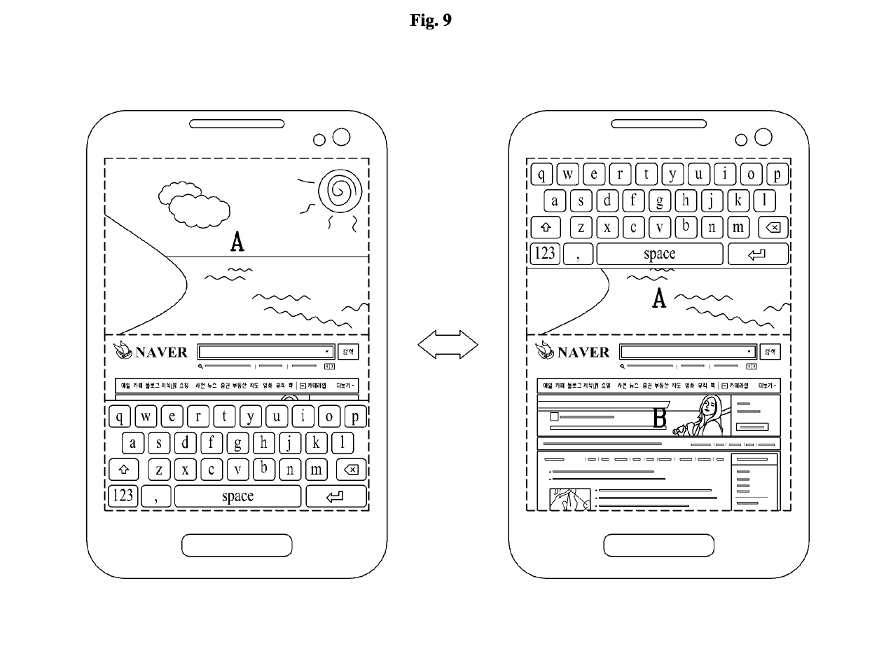

FIG. 9 illustrates an image processing apparatus for processing a display of the screen-touch keyboard when at least two screens are displayed according to an embodiment of the present invention.

If the display panel of the image processing apparatus is divided into a plurality of regions and each screen is displayed at each screen, the image processing apparatus can display the screen-touch keyboard at a specific region from among the divided regions. That is, according to user's input or automatic control of the image processing apparatus, the image processing apparatus can control the screen-touch keyboard to be displayed at a region where the user's concentration on the screen is not interrupted.

Referring to FIG. 9, the screen-touch keyboard may be displayed at a lower end of the display panel, and the image processing apparatus may shift the display position of the screen-touch keyboard to an upper end of the display panel.

If the A screen is focused by the user, the image processing apparatus can control the screen-touch keyboard to be displayed on the B screen. Alternatively, if the B screen is focused by the user, the screen-touch keyboard may be displayed on the A screen.

The user can move the display position of the screen-touch keyboard to another position through his or her simple input action.

For example, the user may use a volume control button located at a side of the image processing apparatus. If the user presses a volume-UP button, the screen-touch keyboard is displayed at an upper end of the display panel. If the user presses a volume-DOWN button, the screen-touch keyboard may be displayed at a lower end of the display panel.

In another example, if the image processing apparatus receives a button input signal through one simple input button, the display position of the screen-touch keyboard may be shifted from a first screen region to a second screen region from among a plurality of screen regions. Upon receiving an input signal of the corresponding button, the image processing apparatus re-shifts the screen-touch keyboard of the second screen to the first screen region so that the screen-touch keyboard is displayed on the first screen region. If a third screen exists, the screen-touch keyboard may be shifted to the third screen and displayed on the third screen.

The image processing apparatus changes a display region of the screen-touch keyboard, such that the resultant screen-touch keyboard can minimize deterioration of the user's concentration on the screen.

FIG. 10 is a block diagram illustrating an image processing apparatus for processing at least two screens according to an embodiment of the present invention.

The image processing apparatus according to an embodiment of the present invention includes an input reception device 10100, a processor 10200, and a display device 10300. The input reception device may include a pupil recognition sensor 10110.

The input reception device 10100 receives a user input signal. The user input signal includes a user's screen-touch input, a user's button input of the image processing apparatus, a user's voice input, a user's motion input, and/or an input of a user located at a remote site.

The pupil recognition sensor 10110 is used for receiving a user input signal so as to recognize the position of the user's pupils. That is, the pupil recognition sensor 10110 is used to identify which one of the screen regions is focused by the user's pupils. In order to more accurately determine the user's pupil position, two or more pupil recognition sensors may be contained in the image processing apparatus.

The processor 10200 provides overall control of the image processing apparatus. The processor 10200 receives and processes a user input signal. The processor 10200 controls display of the display device 10300. That is, the processor 10200 controls arrangement of individual images in such a manner that two or more screens and the screen-touch keyboard can be effectively displayed on the display device.

The display device 10300 includes a series of devices for outputting images to be displayed for the user. The display device 10300 includes a display panel (not shown).

Although respective devices of the image processing device shown in FIG. 10 have been exemplarily described for convenience of description, the image processing apparatus are configured to perform various operations associated with displaying of at least two screens and the screen-touch keyboard shown in FIGS. 1 to 9. Therefore, it will be apparent to those skilled in the art that the operations and contents of FIGS. 1 to 9 can be applied to respective devices of FIG. 10.

Although the embodiments shown in the drawings are separately described for convenience of description, the embodiments may be combined into a new embodiment. If necessary, a computer-readable recording medium having a program recorded thereon for executing the above-described embodiments is included in the scope of the present invention.

The image display apparatus and the method for operating the same according to the foregoing exemplary embodiments are not restricted to the exemplary embodiments set forth herein. Therefore, variations and combinations of the exemplary embodiments set forth herein may fall within the scope of the present invention.

The method for operating an image display apparatus according to the foregoing exemplary embodiments may be implemented as code that can be written on a computer-readable recording medium and thus read by a processor. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission over the Internet). The computer-readable recording medium can be distributed over a plurality of computer systems connected to a network so that computer-readable code is written thereto and executed therefrom in a decentralized manner. Programs, code, and code segments to realize the embodiments herein can be construed by one of ordinary skill in the art.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

Both the product invention and the process invention are described in the specification and the description of both inventions may be supplementarily applied as needed.

As is apparent from the above description, the image processing method and apparatus according to the embodiments of the present invention, when at least two screens and the screen-touch keyboard are used by a user, can enable the user to conveniently use the screens and keyboard without any restriction.

In accordance with one embodiment of the present invention, display of the screen-touch keyboard can be adjusted in a user-desired direction.

### MODE FOR INVENTION

Various embodiments have been described in the best mode for carrying out the invention.

### INDUSTRIAL APPLICABILITY

The image processing apparatus according to the embodiments of the present invention are applicable to a variety of industrial fields.

What is claimed is:

1. An image processing apparatus for processing two or more screens, comprising:
a display panel for displaying a first screen and a second screen;
a user input unit for receiving a user input signal; and
a processor for dividing each of the first screen and the second screen into a main screen and a sub screen in response to the user input signals, displaying a screen-touch keyboard for inputting a letter, adjusting the position or size of at least one screen from among the first screen and the second screen, and displaying the adjusted resultant screen,
wherein the processor, if the letter input caused by the screen-touch keyboard is ended, controls the position or size of at least one screen from among the first screen and the second screen to return to their original position or size of the at least one screen, and displays the at least one screen having the original size at their original position,
the processor maintains a predetermined position and size of the screen-touch keyboard, irrespective of adjustment of the position or size of the first screen and the second screen, so that the resultant screen-touch keyboard is displayed, and
the processor controls a main-screen indicator for identifying a screen identified as the main screen to be displayed.

2. The image processing apparatus according to claim 1, wherein, in order to display a region of the screen-touch keyboard, the processor reduces the first screen and the second screen at the same ratio, and displays the reduced first and second screens.

3. The image processing apparatus according to claim 1, wherein a screen focused by the user from among the first screen and the second screen is identified as the main screen, and the remaining screen is identified as the sub-screen.

4. The image processing apparatus according to claim 3, further comprising:
a pupil recognition sensor for collecting information regarding a user's pupil position,
wherein the processor identifies the first or second screen focused by the user's pupil as the main screen on the basis of the collected pupil position.

5. The image processing apparatus according to claim 3, wherein the processor identifies a user-touched screen from among the first screen and the second screen as the main screen.

6. The image processing apparatus according to claim 3, further comprising:
a voice input receiver for receiving a user's voice input signal,
wherein the processor identifies the first or second screen designated by the received user's voice input, as the main screen.

7. The image processing apparatus according to claim 3, wherein the processor zooms out and reduces only the sub-screen so that the resultant sub-screen is displayed.

8. The image processing apparatus according to claim 3, wherein:
the processor shifts the main screen or the sub-screen by a predetermined distance corresponding to a display region of the screen-touch keyboard, and displays the main screen or the sub-screen at the shifted position; and
the processor, if the main screen overlaps with the sub-screen due to the shifting action, controls the main screen to be displayed at the overlap region.

9. The image processing apparatus according to claim 3, wherein the processor shifts the main screen or the sub-screen by a predetermined distance corresponding to the display region of the screen-touch keyboard, divides a predetermined-sized region corresponding to the shifted region from the sub-screen, and displays the resultant screens.

10. The image processing apparatus according to claim 3, wherein the processor controls the screen-touch keyboard to be displayed on the sub-screen.

11. The image processing apparatus according to claim 1, wherein the display panel is located at one side of the image processing apparatus so as to simultaneously display the first screen and the second screen.

12. The image processing apparatus according to claim 1, wherein the display panel is located not only at one side but also at the other side of the image processing apparatus, wherein the first screen is displayed at the one side and the second screen is displayed at the other side.

13. The image processing apparatus according to claim 2, wherein the processor rearranges a keyboard of the screen-touch keyboard, and divides the screen-touch keyboard into two regions such that the screen-touch keyboard is displayed on the two regions at left and right corners of the display panel.

14. The image processing apparatus according to claim 2, wherein the processor rotates the first screen or the second screen clockwise or counterclockwise by 90 degrees, and displays the rotated resultant first or second screen.

15. The image processing apparatus according to claim 1, further comprising:
a keyboard trigger for receiving a user input signal for displaying the screen-touch keyboard; and
a location control button for receiving a user input signal for controlling the display position of the screen-touch keyboard.

16. The image processing apparatus according to claim 15, wherein the processor, upon receiving a location control input signal from the user through the keyboard location control button, shifts the screen touch keyboard from the first screen to the second screen of the display screen, and displays the shifted result.

17. The image processing apparatus according to claim 1, wherein the main screen indicator identifies the main screen by adjusting brightness of the screen identified as the main screen, identifies the main screen by increasing transparency of the screen identified as the sub-screen, identifies the main screen by forming a border of the screen identified as the main screen, or identifies the main screen by displaying a predetermined sign on the screen identified as the main screen.

18. An image processing method for processing two or more screens, the method comprising:
displaying a first screen and a second screen;
receiving a user input signal;
dividing each of the first screen and the second screen into a main screen and a sub-screen in response to the user input signals, displaying a screen-touch keyboard for inputting a letter, adjusting the position or size of at least one screen from among the first screen and the second screen, and displaying the adjusted resultant screen, wherein predetermined position and size of the screen-touch keyboard are maintained, irrespective of adjustment of the position or size of the first screen and the second screen, so that the resultant screen-touch keyboard is displayed;
controlling display of a main-screen indicator for identifying a screen identified as the main screen; and
if the letter input caused by the screen-touch keyboard is ended, controlling the position or size of at least one screen from among the first screen and the second screen to return to their original position or size of the at least one screen, and displaying the at least one screen having the original size at the original position.
